(19) United States
(12) Patent Application Publication
(10) Pub. No.: US 2014/0186805 A1
(43) Pub. Date: Jul. 3, 2014

(54) PORTION CONTROL AID AND METHOD OF MAKING AND USING SAME

(71) Applicant: WILLIAM T. PORDY, New York, NY (US)

(72) Inventor: WILLIAM T. PORDY, New York, NY (US)

(21) Appl. No.: 14/174,370

(22) Filed: Feb. 6, 2014

Related U.S. Application Data
(63) Continuation-in-part of application No. 13/074,767, filed on Mar. 29, 2011, now abandoned.
(60) Provisional application No. 61/318,499, filed on Mar. 29, 2010.

(51) Int. Cl. A47G 23/10; G09B 19/00

(52) U.S. Cl. CPC A47G 23/10; G09B 19/0092
USPC 434/127; 29/592

(57) ABSTRACT

A portion control aid and method of making and using the same includes a transparent base with portion-indicating markings. The portion indicating-markings form portion-indicating regions. The size of the portion indicating regions correspond with the size of a perimeter of a portion of food that is equal to a desired or recommended portion. When the food consists of pieces that can be formed in a pile or scoop, the markings are determined by the expected Angle of Repose of the pile or scoop. In use the transparent base is held directly above the portion of food with the portion indicating region generally aligned with the portion of food. If the entire portion of food visually appears to fit within the portion-indicating region, the portion of food contains no more than the desired or recommended portion.

### CROSS-REFERENCE TO RELATED APPLICATIONS

This application is a continuation-in-part of and claims priority under 35 USC §120 to U.S. patent application Ser. No. 13/074,767, filed Mar. 29, 2011, which application is hereby incorporated by reference in its entirety, and which claims priority on Provisional Patent Application Ser. No. 61/318,499, filed Mar. 29, 2010.

### FIELD OF THE INVENTION

The field of this invention is portion control and more specifically to devices and methods for verifying whether portions of food correspond with desired or recommended healthful portions.

### COPYRIGHT STATEMENT

All of the material in this patent document is subject to copyright protection under the copyright laws of the United States and other countries; all copyrights are reserved.

### BACKGROUND OF THE INVENTION

When preparing foods or when eating foods provided by others, such as at a restaurant or when visiting others, there is a need to determine whether an amount of food corresponds with a recommended or desired portion of food. For example the USDA provides dietary guidelines for serving sizes of various foods: the serving size is considered the correct portion or amount. Other organizations also provide guideline for suggested serving sizes so that a user can accurately gauge the amount calories, nutrients and other factors such as salt, fat, carbohydrates, and others. It can be difficult for people to estimate on a visual inspection the right amount This can lead to failure to accurately track the amount of calories and other dietary factors being consumed and the primary cause why approximately 80% of American adults and 33% of children have become overweight and obese.

Every expert chef and any person who cooks knows that almost all meals, recipes and foods mainly and mostly involve cutting and chopping and measuring. Almost every meal and every recipe whether soup, or stew, or a complicated roast, or a simple sauce involves seminally these food preparation steps. We cut and chop and slice and mince almost everything we prepare, and we measure almost always either or both for recipe specifics and/or to ensure the correct calorie and fat and carbohydrate intake and the correct portions of specific foods.

For every cook, beginning and advanced, a knife, a cutting board, a measuring cup (though not a scale in the US as recipes here tend to be with amounts measured in volume not weight), a pot and a pan are essential tools to start preparing meals. And for a number of decades, these primary kitchen tools have evolved to become more helpful and useful. Particularly over the last decade, prior art has been rife with enhancement of cutting boards that include:
A flexible mat, and one with a lower non-slip surface, Scianna, U.S. Pat. No. 5,997,995, and Thompson, U.S. Pat. No. RE 36,717, May 30, 2000;
Removable, disposable, exchangeable and replaceable cutting surface to prevent cross-contamination with food preparation and inhibit food liquid from sliding off the surface, Bogomolny, U.S. Pat. No. 5,984,294, Cant, U.S. Pat. No. 6,164,478, Willen at alia, U.S. Pat. No. 7,533,875, Zeng, U.S. Pat. No. 7,637,488 B2, and, Lim et alia, U.S. Pat. No. 7,758,029;
A magnetic cutting board to be stored vertically and out of the way on a refrigerator etc., McLaughlin, U.S. Pat. No. 7,125,011;
A cutting board that incorporates into a countertop and over a basin reservoir, Shamroth, U.S. Pat. No. 7647,654 B2;
A cutting board with an adjustable desired height, Whelan, U.S. Pat. No. 7,849,789 B1;
A cutting board containing a removable knife sharpener and one containing a protective fence to increase safety while cutting and chopping, Aviles, U.S. Pat. No. D630,914, DiNatale, U.S. Pat. No. 7874,549;
A cutting board that also functions as a plate or a serving tray, Norton, U.S. Pat. No. D622,558, Shamoon, U.S. Pat. No. D629,268; and
A food preparation board with multiple measurement zones, Kishbaugh, US Patent Application Publication No. 2006/0108730.

All of these cutting boards with incremental and secondary advantages offer features that may be of help and use, but they do not offer benefits of inclusion with other kitchen tools and preparation functioning such as measuring. The prior devices with measuring devices integrated and/or associated with the cutting boards may be inchoate and not simple to use, may be complicated and difficult, may require a considerable amount of space and clean up, and may have variable accuracy. For example, a cutting board with shallow and long (the length of the cutting board) cups attached at the edge of the cutting board was shown at the 2011 International Housewares Show and claimed to be patent pending and retail for approximately $35.00. Not only is the price prohibitive when compared even to the cost of any high-value material cutting board and a well manufactured measuring cup, but also the very low height and very long length of the cups and thus its very large surface area will lead to significantly variable and non-reproducible measurements. Too, Keener, U.S. Pat. No. 6,478,293 B2, Casale, U.S. Pat. No. 7,530,558 B2, and Shew, U.S. Pat. No. 7,681,871 B2 have trough containment space, a bottom storage space or a removal scoop to collect foods and fluids that can also measure the volumes of what is inside. These are not readily adopted by the market because of the additional user actions required and their likely relative cost. Some other failings including cumbersome to continually measure and not easy to store and reassemble may be found with Robbins' adjustable measuring container attached to a cutting board, U.S. Pat. No. 7,637,154 B1.

The current invention first uses the physics of the Angle of Repose to create and place on the cutting board two-dimensional flat measuring indicia. The function of the Angle of Repose and its ability to measure foods or other substances once cut and chopped can be defined as a body resting on a plane, inclined at an angle a to the horizontal plane, in a state of equilibrium when the gravitational force tending to slide the body down the inclined plane is balanced by an equal and opposite frictional force acting up the inclined plane. Although the physics is complicated, the two dimensional indicia based on the Angle of Repose is very simple and easy to use: The user can cut, chop and measure all in one place and all at one time, and can save prep time, particularly for complicated and involved recipes, save counter and storage space as all of the functions are on the single board, including features additional to cutting chopping and measuring described below, and save clean up. Secondly, the current invention uses two-dimensional flat indicia to measure cut and chopped substances of similar or equal density and similar or equal height. Thirdly, the current invention uses specific areas and indicia to measure specific amounts, and portions, of foods that are formed and served in a pile or a scoop.

The current invention makes cooking easier by cutting, chopping and measuring all at once and all in one place. Further and of seminal importance, the current invention with measurement of general amounts and specific portions of specific foods also makes healthy eating and living easier, of particular importance as obesity and childhood obesity have become a very critical and influential issue here in the United States.

Currently 80% of US adults are overweight and obese, and 33% of children are overweight and obese (41% in NYC) across all socio-economic demographics. The weight of the average adult male passenger that had been 150 pounds in the 1960s and is now according to the CDC 194.7 pounds, and the percentage of childhood obesity has increase over 300% since the 1970s. There are many local, national and corporate policies and programs involved with the current obesity pandemic, and the Dietary Guidelines for Americans 2010, released Jan. 31, 2011, summed up the problem and said “Enjoy your food but eat less.” Calories do count but portions count more, and with the current invention, children and adults can measure, learn and measure and know the correct portions of foods that they do eat and that they should eat.

Accordingly, the present invention allows an individual to visualize the calories associated with a food portion without having to actually count the calories. It is a quick, easy and personal way to judge the correct portion of foods. It is entirely non-judgmental and does not involve guilt, criticism, interference or obstruction. It does not require extra food preparation time. It is a simple, user friendly portion control method which allows one to eat less by visualizing the volume of food being consumed.

### SUMMARY OF THE INVENTION

What is needed is a device that improves and makes effortless the major actions used for cooking preparation: cutting, chopping and measuring foods. This invention makes these methods customarily used for all cooking significantly easier. Further, this invention makes healthy eating and living simpler and better by knowing and learning the correct amounts and right portions of foods and additionally by helping users choose the right foods. This invention provides a significant improvement for every kitchen, every cook and every meal.

There is also a need for a device that can permit a user to conveniently and easily determine whether a portion of food corresponds with recommendations for portion or serving size.

Therefore, one object of the present invention is to provide a portion control device that permits a user to verify whether a food portion on a plate or other flat surface contains more, the same, or less than a recommended portion of food.

Therefore, it is an object of this invention to provide a means for measuring on the same board on which you cut and chop foods so that the user may do so all in one place and all at one time. Additionally, the user may be able to pour or transfer the prepared foods into a pot, or bowl, plate or pan pending the material of which the board is made or how the material is constructed.

It is another object of this invention to ease food preparation and save preparation time, to save both counter and storage space and to decrease needed clean up.

It is another object of this invention to help the user confirm the amount of foods they want and help them reduce caloric intake and count calories.

It is another object of this invention to provide the distinct measuring areas for varying and distinct units of measurement, e.g., cups and fractions thereof for cutting and chopping vegetables and fruit, teaspoons and tablespoons for slicing and mincing herbs.

It is another object of this invention to provide a built-in strainer so the user can rinse and drain, cut and chop, measure, and transfer and pour pending the board's material all in one place all at one time.

It is another object of this invention to provide the distinct, usual and needed measurements for different category of foods: Vegetables, fruit and fresh foods, chicken or fish, and meats and thus help prevent cross-contamination with the use of different boards.

It is another object of this invention to provide methods for measuring, learning and knowing the correct amounts and right portions of specific foods.

It is another object of this invention to provide several simple methods of portion control particularly well suited for use by children and which can be personalized with their specific names and on which they can color; those for adults may be smaller and simpler.

It is another object of this invention to provide for laboratories, manufacturing et alia, easily and quickly and accurately samples of needed weights with substance of specific density and height.

### BRIEF DESCRIPTION OF DRAWINGS

FIG. 1 is a top view of a cutting board according to one embodiment of the present invention with measuring indicia identifying measurements in cups and fractions thereof and ounces. Partial top and side views show 1 cup of chopped celery inside the 1 cup area on the cutting board and measurement confirmation in a measuring cup.

FIG. 2 is a top view of a cutting board according to one embodiment of the present invention with measuring indicia identifying measurements in ounces and pounds and fractions thereof. Partial top and side views show six ounces of a single layer of standard thickness of chicken inside the 6 ounce measurement area and measurement confirmation on a scale.

FIG. 3 is a top view of a cutting board according to one embodiment of the present invention with measuring indicia identifying measurements in pounds and fractions thereof and ounces. Partial top and side views show six ounces of a single layer of standard thickness of meat inside the area and measurement confirmation on a scale.

FIG. 4 is a top view of a cutting board according to one embodiment of the present invention with measuring indicia identifying measurements in teaspoons and tablespoons. Partial top and side views show 1 tablespoon of chopped basil inside the 1 tablespoon area and measurement confirmation in a measuring spoon.

FIG. 5 is the top view of a cutting board according to one embodiment of the present invention that is similar to the embodiment in FIG. 1 except that the embodiment of HG.-FIG. 5 includes holes in the measuring area so that the measuring and cutting board can also function as a strainer.

FIG. 6 is a top view of a cutting board according to one embodiment of the present invention with measuring indicia (circles) identifying specific measurements and correct portions of specific foods. Partial top and side views show 1 ounce of potato chips inside the specific circle and measurement confirmation of the correct amount on a scale.

FIG. 7 is a top view of the cutting board of FIG. 6 with measuring indicia (circles) identifying specific measurements and correct portions of specific foods. Partial top and side views show 3.5 ounces macaroni and cheese inside the specific circle and measurement confirmation of the correct amount on a scale.

FIG. 7A is a top view of the same measuring and cutting board in FIG. 7 with a top view of the same portion of macaroni and cheese as shown in FIG. 7 inside the next larger measurement circle showing a significant amount of empty space within the circle confirming that this larger circle is the incorrect measurement of 3.5 ounces macaroni and cheese.

FIG. 8 is a top view of the cutting board of FIG. 6 with measuring indicia (circles) identifying specific measurements and correct portions of specific foods. Partial top and side views show Y2 cup of canned fruit inside the specific circle and measuring cup confirmation of the amount.

FIG. 9 is a top view of the cutting board of FIG. 6 with measuring indicia (circles) identifying specific measurements and correct portions of specific foods, and there are top and side views of 1 cup of canned ravioli inside the specific circle and measuring cup confirmation of the amount.

FIG. 10 is a top view of the cutting board of FIG. 6 with measuring indicia (circles) identifying specific measurements and correct portions of specific foods. Partial top and side views show a single layer of chicken nuggets within that circle and confirmation of the correct amount and portion on a scale.

FIG. 11 is a top view of the cutting board of FIG. 6 with measuring indicia (circles) identifying specific measurements and correct portions of specific foods. Partial top and side views show a scoop of ice cream within the circle and declaration that two scoops of ice cream within that circle is the correct portion: ½ cup.

FIG. 12 is a top view of a cutting board according to another embodiment of the present invention with measuring indicia (circles and a triangle) identifying specific measurements and correct portions of specific foods. A top view shows a correct slice of pizza inside the triangle.

FIG. 13 is a top view of a cutting board with independent and removable measuring indicia (“lock and key” circles) that are the size of specific measurements and correct portions of specific foods. Also shown are several examples of specific food measurements and a “lock and key” connections of three foods and to form a healthful meal with correct portions.

FIG. 14 is a bottom view of the cutting board on FIG. 13.

FIG. 15 is a top plan view of a portion control aid according to one embodiment of the present invention;

FIG. 16 is a top plan view of a plate of food including a pile of a first food, a single layer of a second food and a piece of pizza.

FIG. 17A is a partial side view of the plate of FIG. 16 with a portion control aid immediately above the pile of the first food in order to determine whether the pile contains more or less than a recommended portion of the first food.

FIG. 17B is a top plan view of FIG. 17A wherein the pile of the first food includes more than a recommended portion.

FIG. 17C is a top plan view of FIG. 17A wherein some of the food has been removed so that the pile of the first food includes about the recommended portion.

FIG. 18A is a partial side view of the plate of FIG. 16 with a portion control aid immediately above the single layer of the second food in order to determine whether the layer contains more or less than a recommended portion of the second food.

FIG. 18B is a top plan view of FIG. 18A wherein the single layer fits within a portion indicating outline indicating that the single layer contains no more than a desired portion.

FIG. 19A is a partial side view of the plate of FIG. 16 with a portion control aid immediately above the piece of pizza in order to determine whether the piece of pizza corresponds with a recommended portion of pizza.

FIG. 19B is a top plan view of FIG. 19A, wherein the single piece of pizza extends beyond the portion indicating outline, indicating that the slice of pizza is larger than the recommended portion.

### DETAILED DESCRIPTION OF PREFERRED EMBODIMENTS

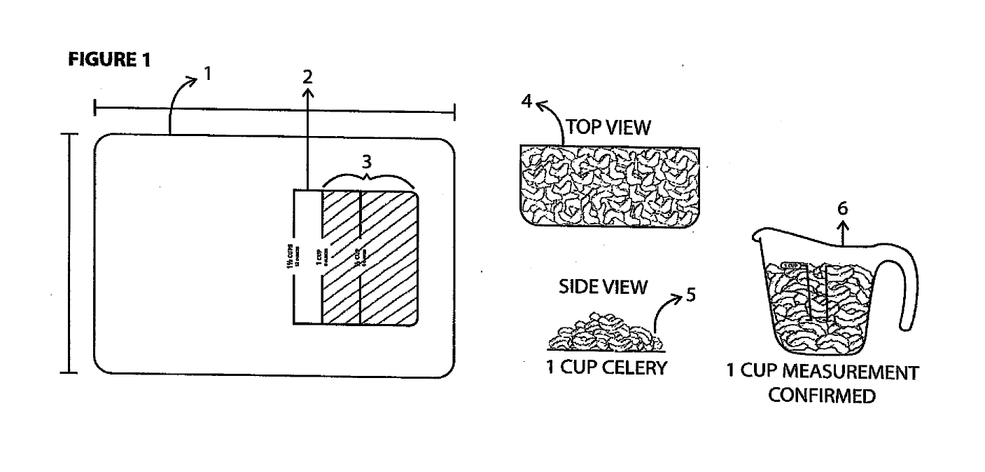

FIG. 1 shows a top view of a preferred embodiment of a cutting board (1) with a measurement indicia (2) on its planar surface. The height and length of the cutting board can be variable although the preferred embodiment for a kitchen cutting board in this figure is 15 inches in length and 11½ inches in height. The measurement indicia (2), functioning through the law of the Angle of Repose, cannot have its two-dimensional size changed though its shape may be adjusted; in this Figure, the 1 cup measurement indicia (3) is 5½ inches in height and 3¾ inches in length. FIG. 1 also shows the example of cutting, chopping and measuring 1 cup of celery—(4) and (5), and measurement confirmation (6). The 1 cup area is indicated in FIG. 1 with cross-hatched shading.

It matters little how big or small the user cuts and chops the celery, the result will be approximately the same. The user slides the chopped celery over to the measurement indicia (2)—top and side view (4) and (5)—and place it within the 1 cup indicia (3). Through the Angle of Repose, the equilibrium between friction and gravity, you can only pile up the chopped celery until it falls down, and note that the 1 cup indicia is not twice the size (surface area: 5½ inches by 3¾ inches) of the ½ cup indicia (surface area: 5½ inches by 2¼ inches) as the bigger the base, the taller the pile will be because of the angle of repose. The cutting board of FIG. 1 also includes markings for measurement of 1½ cups (5½ inches by 4⅞ inches). Measurement is confirmed in a measuring cup (6).

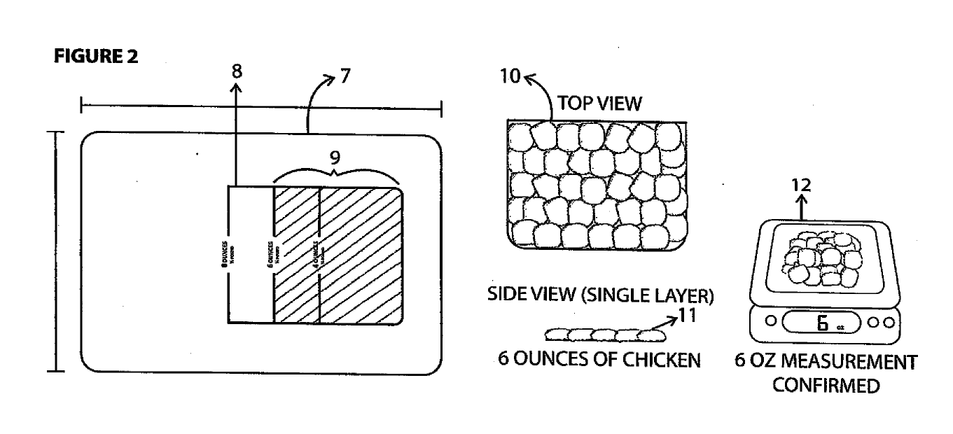

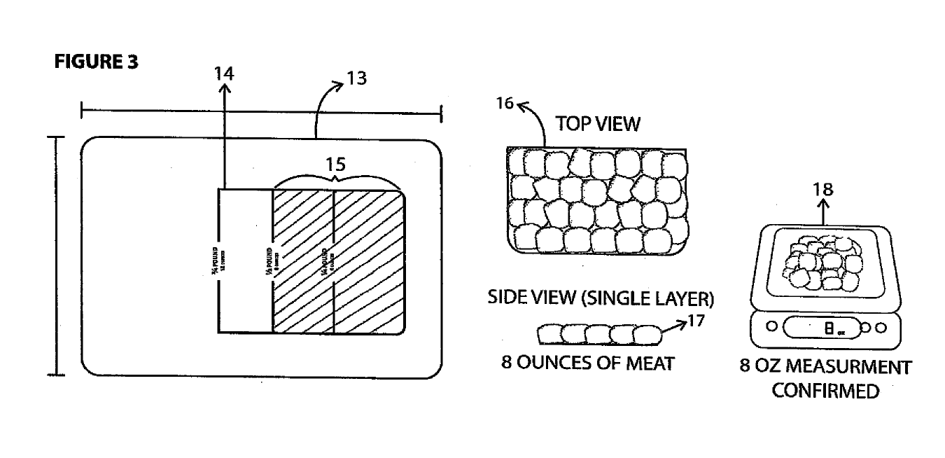

FIGS. 2 and 3 show a preferred embodiment cutting board for chicken and fish FIG. 2 and meats FIG. 3. These boards measure based on the typical thickness (½ inch for deboned chicken and fish and 1 inch for meats) and similar or equal densities in each category and when the user cuts and chops the layer of foods and slides it over to the measuring indicia, (8) and (14) respectively. Because of the difference in the average product height and natural density of the two food categories, the measuring indicia for chicken and fish is different than for meats. The 6 ounce indicia for chicken and fish (9) is 5½ inches by 5 inches and is similar to but larger than the 8 ounce (112 pound) indicia for meats (15) that is 5½ inches by 4⅞ inches. The chicken and fish cutting board shown in FIG. 2 also includes markings at 3¼ inch and 6¾ inch to indicate 4 and 8 ounces of meat respectively. A 2⅞ inch height marking and a 6⅞ inch height marking are provided to indicate ¼ and ¾ pound of meat respectively. Measurements are confirmed on a scale for both categories (12) and (18).

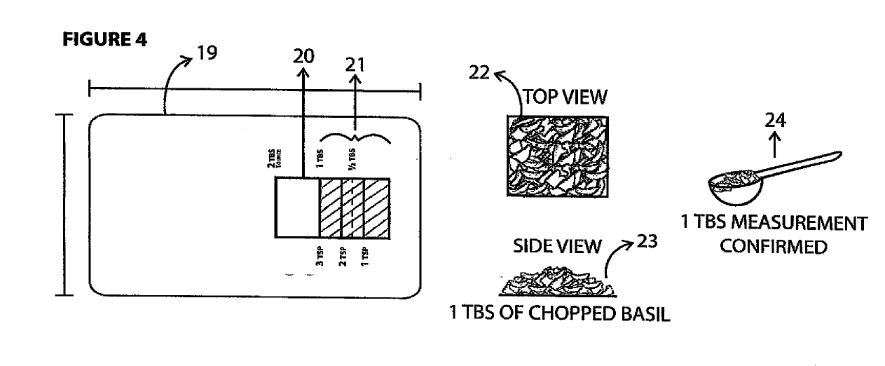

FIG. 4 is a cutting board with measurement indicia in teaspoons and tablespoons (and ounces) for herbs and savories: garlic and onion. Although the board can be of any size, given the smaller size of the foods and the smaller amounts cut, chopped, sliced and minced, the preferred embodiment is 7½ inches in height by 11½ inches in length. As noted above, the measurement indicia cannot have its two-dimensional size changed though its shape may be adjusted; in this figure, the 3 teaspoons (1 tablespoon) measurement indicia (21) is 1¾ inches in height and 2 inches in length. The markings for 1 teaspoon (¾ inches in height), 2 teaspoons (1⅜ inches in height), and 2 tablespoons, or 1 ounce, (2 inches in height) are also provided. (22) and (23) show the top and side view of 3 teaspoons (1 tablespoon) of basil cut and chopped and covering the 3 teaspoons (1 tablespoon) measurement indicia (21); measurement is confirmed in a measuring spoon (24).

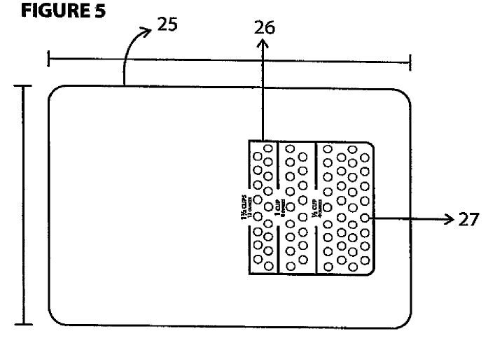

FIG. 5 is a value-added version of the cutting board in FIG. 1 with a plurality of holes (27) placed within the board—in this preferred embodiment within the measurement indicia (26)—so that the user can rinse and drain, then cut and chop, measure and easily transfer the prepared foods form the board into a pot, plate or pan pending the material or the manufacturing design of the board. The cutting board of FIG. 5 can thereby function as a strainer or colander.

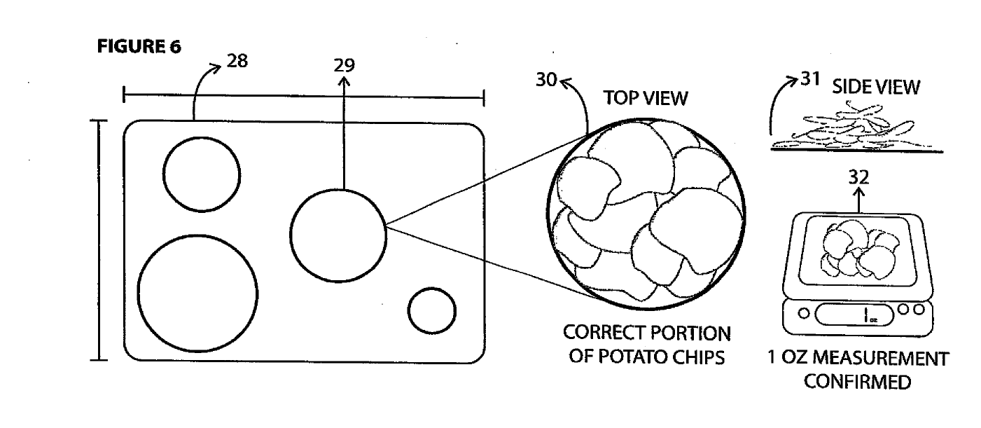

FIGS. 6, 7, 7A, 8 and 9 show the preferred embodiments of cutting boards with measurement indicia to measure specific amounts of various and many specific foods, including many of the top 25 food categories as published in The Dietary Guides for Americans and recognized by the USDA; the indicia could also be used to measure varying amounts of a specific food. In FIG. 6, the 4.25 diameter circle indicia (29) measures the correct portion of potato chips as determined by the USDA, RACC (Reference Amounts Customarily Consumed) et alia and printed on product Nutrition Labels. As described above and based on the Angle of Repose, any potato chips more than the correct amount: 1 ounce will fall outside the circle indicia when piled up, top and side view (30) and (31). Measurement is confirmed on a scale (32). It has been determined that regardless of the size, or texture of the potato chips, the portion determined by the Angle of Repose will be approximately the same.

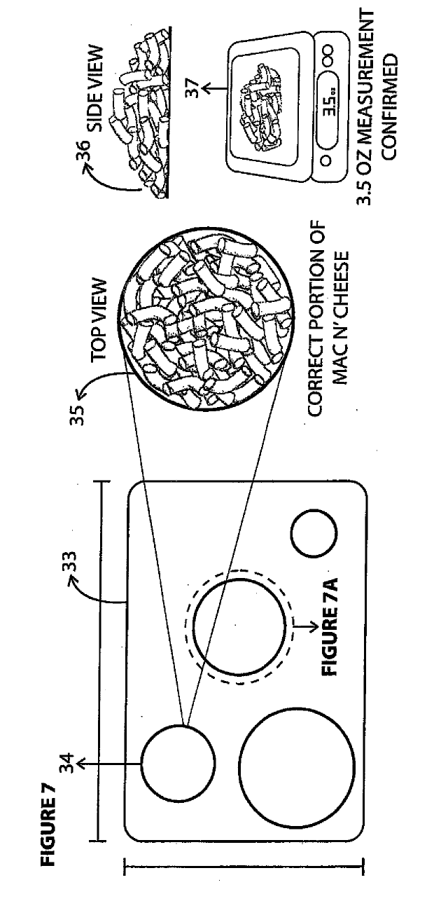

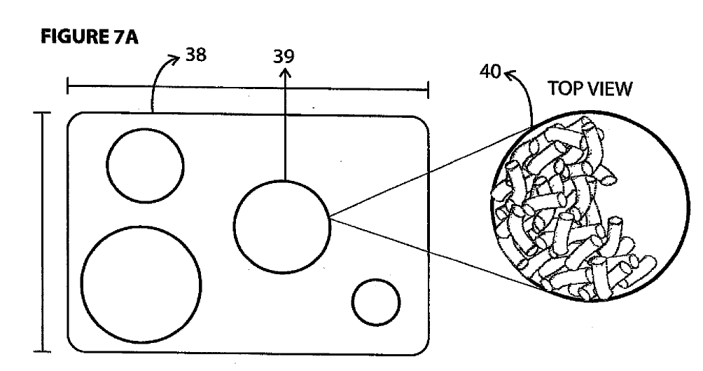

FIGS. 7 and 7A have the same indicia and measure the correct portion of macaroni and cheese: 3.5 ounces based on USDA, RACC et alia. In FIG. 7, the circle indicia with a 3.6 inch diameter (34) measures the correct portion of a scoop of macaroni and cheese, top and side view (35) and (36); measurement is confirmed on a scale (37). In FIG. 7A, the same amount of macaroni and cheese is placed on the next larger circle indicia with a diameter of 4.25 inches (39); that same portion only fills about 65% of the circle, and thus it is known not to be the correct amount and the actual amount wanting to be measured. In this preferred embodiment, the board is made of a flexible polyethylene 0.020 inches thick and translucent so that the user can easily match up the portion on a plate instead of measuring it on the board; too, if young children use the board, they can color on the underside with the printed indicia with nontoxic erasable and recolorable markers, crayons or color pencils. The board could also be made of YUPO brand synthetic papers which are extruded from polypropylene pellets. This and all other preferred embodiments can also function as a placemat.

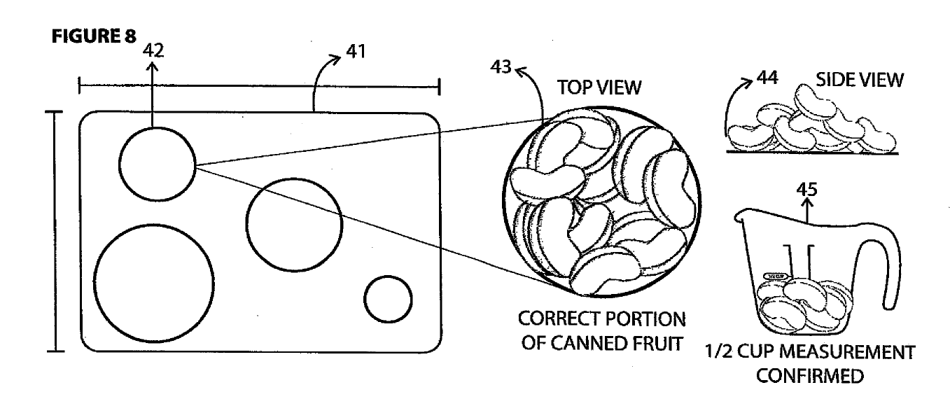

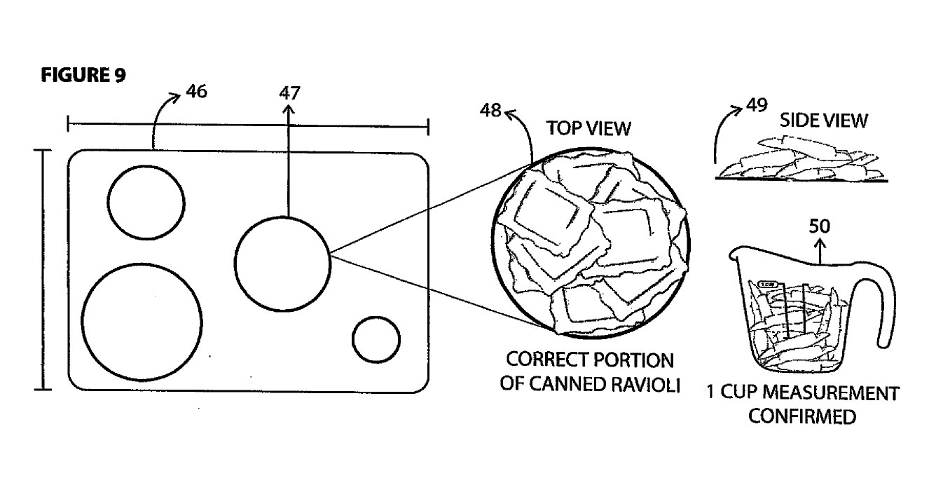

FIGS. 8 and 9 demonstrate the same preferred embodiment measuring the specific amount and correct portion of canned fruit (1½ cup) and canned ravioli (1 cup) on two different circle indicia (42) and (47). The top and side views are shown in (43) and (44) (canned fruit) and (48) and (49) (canned ravioli), and measurements are confirmed in measuring cups, (45) and (50) respectively. The portion size measured by this method will be approximately the same even if the size and texture of the pieces differ.

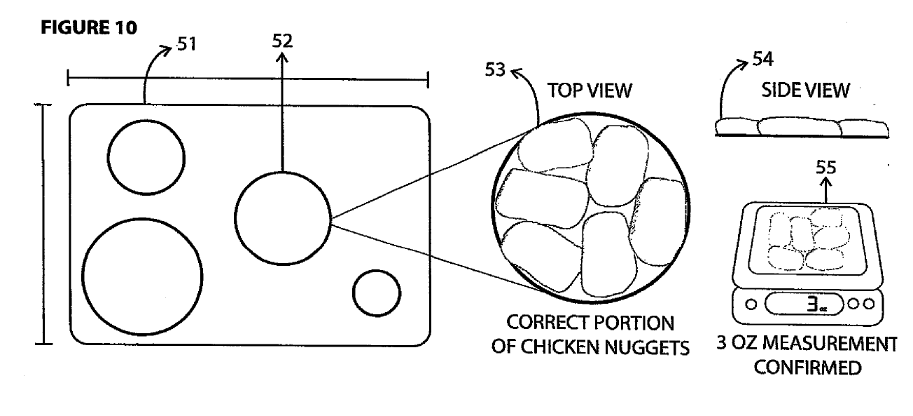

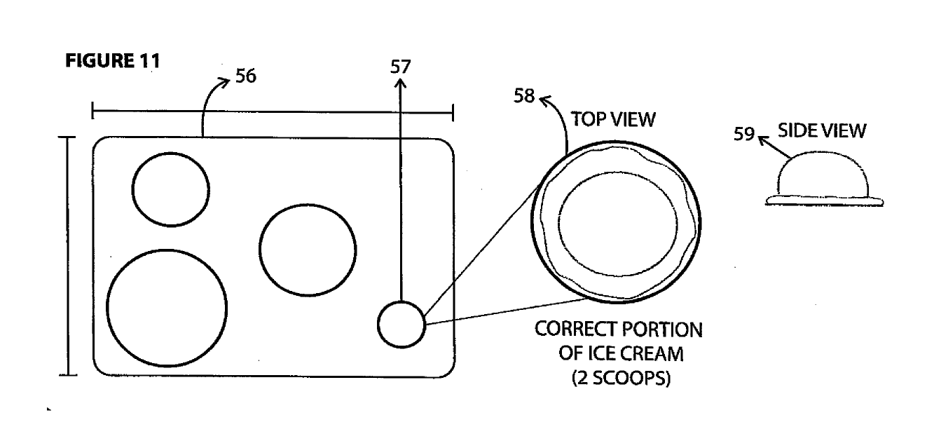

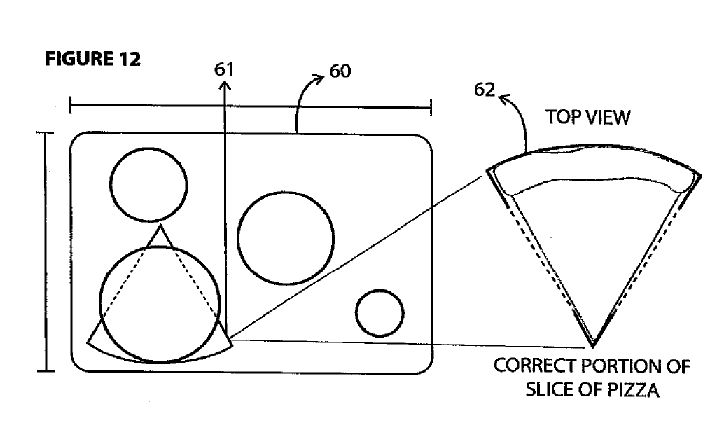

FIGS. 10, 11 and 12 show an additional use of the embodiment of FIG. 6 for measuring the actual portions used of various specific foods based on a single layer instead of a pile or a scoop formed by the Angle of Repose as shown in FIGS. 6-9. In FIG. 10, 3 ounces of cooked chicken nuggets fill the circle indicia with a diameter of 4.25 inches (52) and (53) in a single layer (54). In FIG. 11, two scoops of ice cream that filled the circle indicia (57), (58) and (59) make and measure ½ cup, the correct single portion of ice cream per USDA, RACC et alia. In FIG. 12, a slice of pizza the size of the triangle indicia (61) is the general correct portion based on Nutrition Labels regardless of the variation in calories pending ingredients. Therefore, it should be appreciated that the present invention permits use of the same cutting board for measuring portions that are produced and measured either in a pile, a scoop or a single layer (not a stack) of larger pieces.

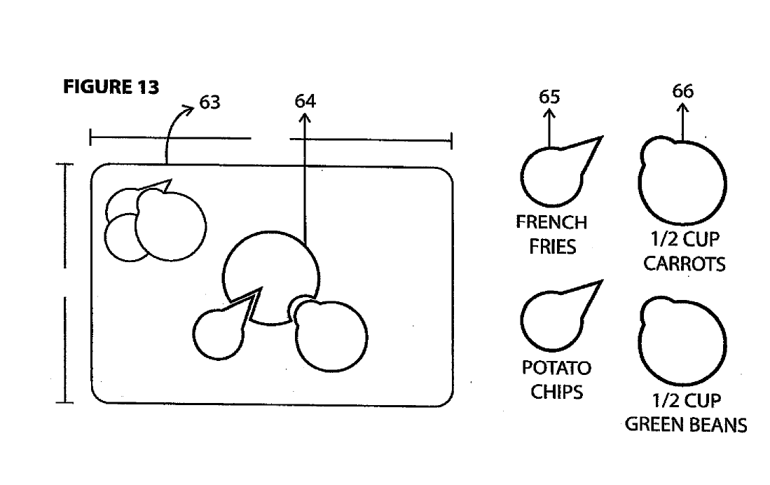

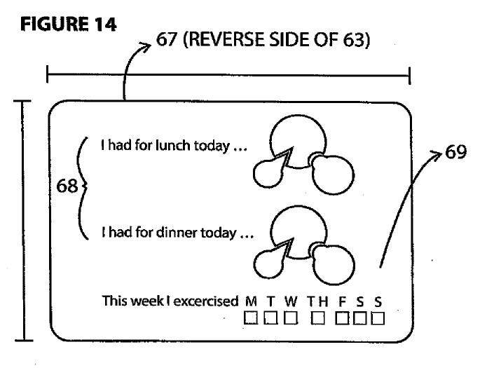

FIGS. 13 and 14 show a preferred embodiment, top and bottom, respectively, with removable replaceable, interactive and combinable measurement indicia to create the correct amounts of many specific foods and meals. In FIGS. 13, (63), (65) and (66) show flexible, thin removable and “lock and key” combinable of many specific foods; (64) shows how three portions of three different foods can be combined. It is not required that the indicia be flexible and thin and removable—they may be movable on an electronic touch screen for example—nor is it required that they be interactive and combinable by “lock and key” appendices, there are numerous methods that can restrict, permit and encourage combined indicia and portions of multiple and various foods.

FIG. 14 shows a possible design for a bottom of the cutting board shown in FIG. 13. According to these embodiments, the indicia may be removable and replaceable, or movable within a fixed or variable location. The indicia may be interactive and combinable, measuring precise and variable amounts of multiple specific foods, singularly and together. For example, the pieces could be shaped and sized to fit together to form a predetermined design. This design could further represent a healthful meal. According to the embodiment with movable and replaceable indicia, the removable items that were used on the cutting board to measure portions of food as it was prepared can be attached to the bottom surface to provide an ongoing record of the portions that have been eaten by a user. The removable or movable items may be color coded, or may be coded by shape, or include images, or all three, to help track the types of food eaten. As opposed to removable items, the surface could be a touch screen that permits a user to manipulate the indicia, and, if transparent, to match it with plates or bowls or other serving dishes. Additional fields may be provided for a user to track exercise, or other health related in formation. It should be appreciated that rather than being provided on the underside of the cutting board, the surface shown in FIG. 14 might be provided on a separate article, such as a placement or other visual display. In particular, the surface could be a display on any type of electronic device such as an iPad, a smartphone or the like.

The above drawings and description relate to several embodiments of the invention. These embodiments share several features. In general, the measurement indicia (2) may be any marking that is visible to a user to indicate the perimeter of an amount or portion of food. In the embodiment of FIG. 1, the measurement indicia (2) should be sized to indicate the perimeter of a base of a pile of food of a given amount. The indicia (2) may be subdivided into different sized areas to indicate different desired amounts. Alternatively, several separate indicia (2) (see FIG. 6) may be included on the cutting board (1) to indicate different portions. The measuring indicia (2) may be imprinted on the board with ink, laser cut, embossed, debossed, or by other known means. Preferably the indicia (2) will be permanent and will not wash off during cleaning and scrubbing. The size and shape of the indicia (2) will vary according to the Angle of Repose, and can be determined by experimentation prior to the manufacturing of the board (1). It should be appreciated that the board (1) can be used to measure amounts of foods that are designated by weight (e.g., ounces, pounds, grams etc.), volume (e.g., cups, teaspoons, tablespoons, etc.), or other metric (e.g., number of pieces, etc.).

The boards can be used by consumers in schools, homes, restaurants, laboratories, factories, the construction industry, and other industries to measure amounts of substances by the Angle of Repose for piled substances. Further, if the density and height are known for a substance, the two-dimensional surface area will determine the quantity (weight) desired. The quantity of the substance can be predetermined and appropriate indicia can be included on the board to measure that predetermined amount. The indicia can be used to measure the amount of the substance by filling the measuring area with the substance.

The board (1) can be made from any material suitable for use as a cutting board that can have permanent visible markings applied. For example, the cutting board (1) could be made from high-value cutting board material, e.g., maple or bamboo, mid-value cutting board material, e.g., plastic poly board, or low-value cutting board material, e.g., flexible polyethylene or polypropylene. Alternatively, the board (1) could be made from stainless steel that resists the scents of substances being cut, chopped, or sliced. Preferably the board (1) will be made from a material that is easily cleaned, antibacterial, antimicrobial, antifungal, and is dishwasher safe. As a further alternative, the cutting board could be made from a flexible material or materials that permit bending of the planar cutting surface to facilitate pouring and transferring the cut, chopped and measured food portions into a plate, bowl, pot, or pan. Alternatively, the cutting board could be provided with indented lips or brows on the edge in front of the measuring indicia to ease moving cut, chopped and measured food portions into a plate, bowl, pot, or pan. These features are best used when the cutting board is formed from relatively stiff, inflexible, thick material.

The cutting board (1), and in particular the various measuring indicia, permit a user to measure amounts or portions of foods without the need to use separate measuring devices. The invention thereby saves significant time in the preparation of food. The cutting board also thereby saves storage and preparation space, and eliminates the need to wash separate measuring devices. The surface is a substantially planar cutting surface (cutting board) made of any usual materials and the indicia comprise either general measuring areas with varying measurement categories, e.g., cups, teaspoons, tablespoons, ounces, pounds, grams etc., or specific measurement areas, e.g. circles, triangles and circles with indented or extruded areas etc., for varying and precise amounts of specific foods whether these amounts are produced and measured in either a pile, a scoop or a single layer.

According to another feature, the underside of the cutting board may include various printed designs to aid in the appearance and usefulness of the cutting board. For example, cartoon graphics that incorporate shapes similar to the measuring indicia can be printed on the bottom surface of the cutting board to serve as a placemat or plate for children. The children thereby learn the right amounts of the foods they eat and appropriate portion control by placing or matching up their food within the appropriately-sized graphics. Graphics more appropriate for adults may also be used to aid in teaching adults the appropriate sized portions for various foods.

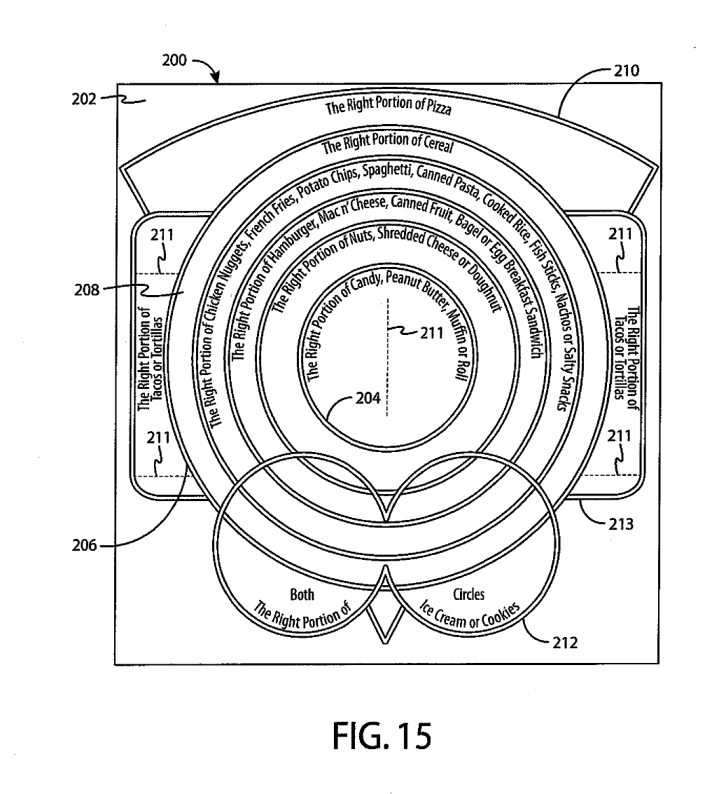

FIGS. 15-19 relate to a portion control aid 200 that can be used to help determine how amounts of food on a plate compare with recommended portions of those foods. Specifically, as seen in FIG. 15, the portion control aid 200 has a transparent base 202 that has markings to indicate the size and shapes of recommended portions of food. The transparent base 202 may be formed from a variety of materials. According to a preferred embodiment, the base 202 can be made from a single sheet of polypropylene. While the exact dimensions of the base are not critical (other than being at least as large as the largest portion of food to be measured), a preferred embodiment may be a square sheet of about 6.25 inches by 6.25 inches. Such a sheet may be easily folded into thirds and stored in a purse or wallet. Indicator lines 211 may be provided on the transparent base 202 to indicate where to fold the base 202 for storage.

As seen in FIG. 15, the base 202 is provided with a plurality of printed markings that indicate predetermined recommended portions for various foods. A series of concentric circles provide guidance for a variety of foods. For example, an inner smallest circle 204 is used to indicate the desired portion of candy or peanut butter. An outer, or largest circle 206, is used to indicate a recommended portion of cereal. As shown, a plurality of sizes of circles may be provided to account for recommended or desired portions of numerous foods or ingredients.

The sizes of the circles are determined based on an expected perimeter of a portion of the corresponding food on a plate or other flat surface. For foods that are provided in piles such as cereal, nuts, dry or cooked pasta, shredded cheese, and the like, the size of the circle will be dependent upon the Angle of Repose of such a pile. For any given product, an Angle of Repose will be approximately the same, with little variation due to the size and the texture of the pieces. Therefore, the size of the base of a pile of the food will be pretty much the same for all piles that include the same amount of that food. For example, an amount of raisins equal to a set portion size that is formed into a file will have a nearly constant perimeter at its base regardless of variations in the size or texture of the raisons. Therefore, the perimeter of a base of a pile of food can be used as an approximate proxy for the amount of food in a pile, for any give food.

Circles or other shapes may also be used to control portion sizes of foods that do not readily form piles with known Angles of Repose. For example, a circle 208 can be marked on the base 202 to form a portion-indicating region for a single layer of chicken nuggets or fish sticks. Additionally, the circle 208 might also be used to indicate the proper portion for a scoop of cooked spaghetti. The actual circles 204. 206 on the base 202 are made slightly smaller than the expected size of the base of the pile of the food to account for the perspective of a user of the aid 200, who will hold it slightly above the pile of food when in use.

It should also be noted that actual weight of purchase products is within the range of plus or minus 10% of the stated net weight. An object of the invention is to provide a simple, user friendly guide for controlling portions within the range of plus or minus 10% of the recommended size using a visual indicator. It is (and it may be) not intended that the invention provide exact portion measurements, which are not necessary or needed for good portion control. Instead, by analogy with the net weight range of purchased products, it is sufficient for good portion control if the invention provides guidance for portion sizes within the range of plus and minus 10% of the recommended size. While such the results may be approximate, they are good enough to provide the necessary guidance to achieve good portion control.

Some foods tend to be provided as a single piece as they are not separable, such as pizza, tacos, or cookies. For these types of foods a shape that corresponds with the size of a desired or recommended portion can be provided. For example a wedge-shaped marking 210 creates a portion-indicating region for a single piece of pizza. Likewise, circles 212 combine to form a single-serving portion corresponding to two cookies or two scoops of ice cream. A rectangular region 213 can be used for tacos or tortillas. Again, the actual sizes of the shapes 210, 212, and 213 are slightly smaller than the outline of the individual portions themselves to account for the perspective of a user who holds the portion control aid 200 above the food on a plate when in use.

Preferably the individual markings for the various portion-indicating regions will be color-coded to make for easier distinguishing of markings that are close to each other. Additionally, writing may be printed on the body 202 to indicate to a user which markings correspond with which foods, and to provide instructions for use.

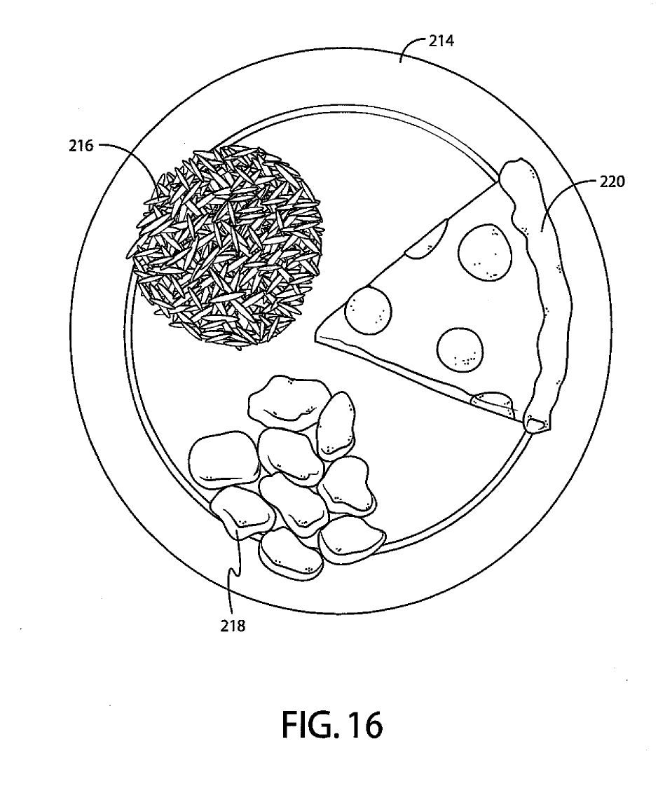

FIG. 16 shows a plate 214 with foods that a user might wish to check for whether the foods exceed a recommended portion. For example, FIG. 16 shows the plate 214 to have a pile 216 of a food such as rice, a single layer 218 of a food such as chicken nuggets, and a single piece 220 of pizza.

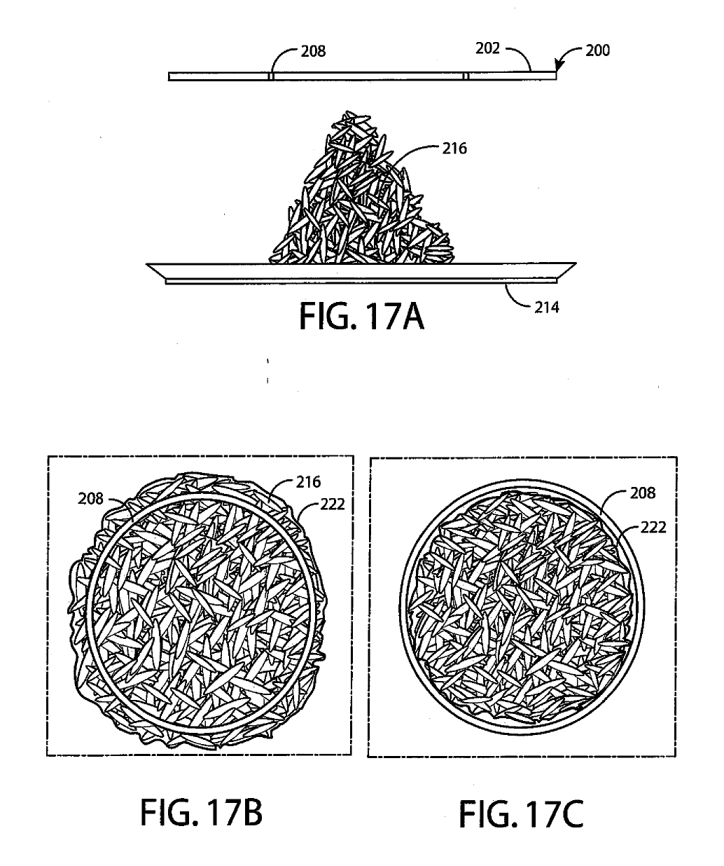

FIG. 17A shows a partial side view of the plate of FIG. 16 with the portion control aid 200 directly above the pile 216. The portion indicating region marked by circle 208 is generally aligned with the pile 216 to determine whether the pile 216 contains more than a desired portion of the food. To make this determination, a user looks through the transparent base 202 to determine whether the perimeter 222 of the pile 216 can be completely contained within the portion-indicating region defined by marking 208.

FIG. 17B shows a top view of the arrangement of FIG. 17A wherein the pile 216 contains more than the recommended or desired portion of food. Accordingly, the perimeter 222 of the pile 216 visually extends beyond the marking 208. This indicates to a user that the pile contains more than the desired portion. A user can then remove some of the food from the pile 216 and re-check to see if the smaller pile 216 fits within the portion-indicating region. FIG. 17C shows the pile 216 from FIG. 17B after some of the food has been removed from the pile 216, such that the perimeter 222 of the pile 216 now is contained completely within marking 208, indicating that the pile 216 contains no more than the recommended portion of food.

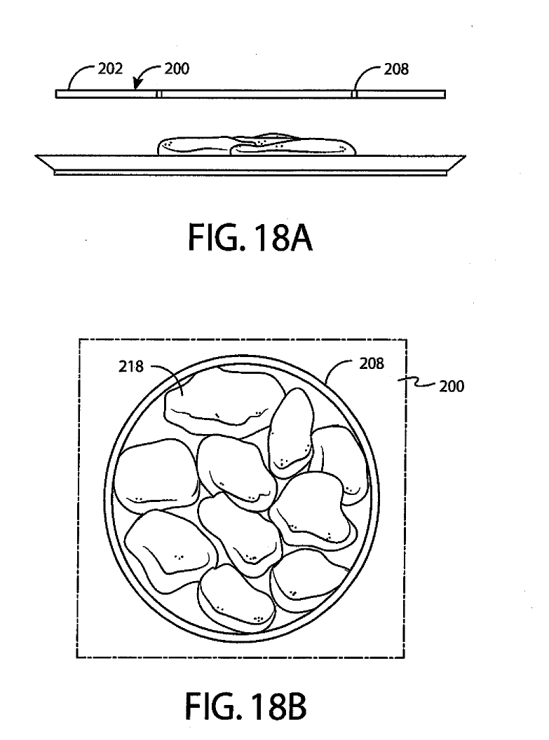

FIG. 18A shows the portion control aid 200 positioned over the single layer 218 of chicken nuggets on the plate 214 from FIG. 16. The portion-indicating region 208 is generally aligned directly above the single layer of food 218. The nuggets should be packed together such that they are touching each other, but not stacked on each other. A user will then look down directly through the transparent base 202 to again determine whether all of the food 218 in the tightly packed single layer will visually fit completely within the portion-indicating region 208. As seen in FIG. 18B, if all of the food 218 appears to fit within the region 208, then the amount of chicken nuggets provided on the plate 214 is no more than a recommended portion. If however, the layer of chicken nuggets extends beyond the border of the region 208, then the layer contains more than a desired portion and some of the nuggets must be removed to achieve the desired portion. However, in making a measurement with relatively large food pieces such as chicken nuggets, one must take into account the space between the pieces within the border and compensate for portions of the nuggets which partially extend beyond the border.

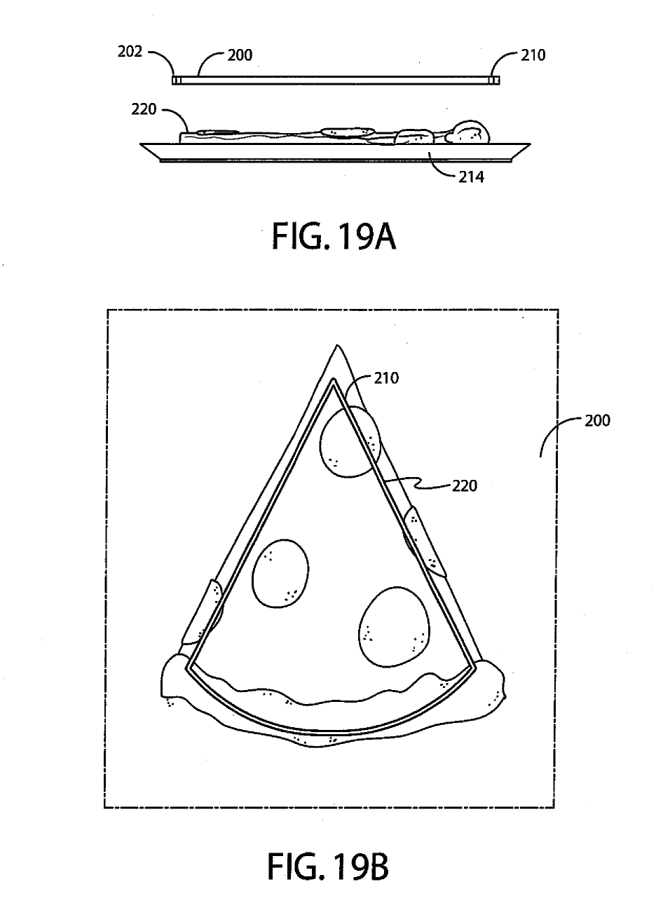

FIG. 19A shows a partial side view of the plate of FIG. 16, with a portion control aid 200 positioned above a single piece of pizza 220. As seen in FIG. 19B, the piece of pizza 220 extends beyond the portion-indicating region 210, indicating that the single piece of food 220 is larger than the recommended portion. A user wishing to eat only the recommended portion should take a smaller piece, cut some of the large piece off, or choose another option.

It should be understood that as used herein the term plate may refer to any generally flat surface on which food might be placed, including a dinner plate, platter, counter top, cutting board, table top, or the like.

The invention has been shown and described above with the preferred embodiments, and it is understood that many modifications, substitutions, and additions may be made which are within the intended spirit and scope of the invention. From the foregoing, it can be seen that the present invention accomplishes at least all of its stated objectives.

What is claimed:

1. A portion control aid comprising:
a transparent base; and
a first marking indicating a first region on the transparent base, the first region corresponding with the approximate expected size and a shape of a perimeter of one of a pile and a scoop of a predetermined portion of a first food determined by the Angle of Repose of the one of a pile and a scoop of the predetermined portion of the first food on a flat surface.

2. The portion control aid of claim 1, wherein the first marking is smaller than the expected size of the perimeter of the one of a pile and a scoop of the predetermined portion of the first food such that when the transparent base is held immediately above the one of a pile and a scoop with the first region aligned with the one of a pile and a scoop, the first marking appears to align with the perimeter of the one of a pile and a scoop to indicate that the one of a pile and a scoop contains the predetermined portion.

3. The portion control aid of claim 1, further comprising a second marking indicating a second region on the transparent base, the second region corresponding with an expected size and a shape of a perimeter of one of a pile and a scoop of a predetermined portion of a second food.

4. A portion control aid comprising:
a transparent base; and
a first marking indicating a first region on the transparent base, the first region corresponding with the approximate expected size and a shape of a perimeter of a predetermined portion of a first food and a second marking indicating a second region on the transparent base, wherein a size and a shape of the second region corresponds with a perimeter of a single layer of a predetermined portion of a second food.

5. The portion control aid of claim 4, wherein the expected size and shape is based on a single layer of the predetermined portion of the first food on the plate.

6. The portion control aid of claim 1, wherein the expected size and shape is based on a single item of the predetermined portion of the first food on the plate.

7. The portion control aid of claim 1, wherein the transparent base includes a marking to indicate at least one location to fold the base for storage.

8. A method of controlling portion size of a food in a first one of a pile and a scoop on a surface, the method comprising:
taking a portion indicator comprising a transparent base and a first portion-indicating outline;
holding the portion indicator directly above the first one of a pile and a scoop of food with the first portion-indicating outline generally aligned with the first pile of food; and
determining whether the first one of a pile and a scoop of food is visually contained within the first portion-indicating outline, whereby if all of the first one of a pile and a scoop of food is visually contained within the first indicating outline, the first one of a pile and a scoop of food contains no more than a desired portion of the food.

9. The method of claim 8, whereby if all of the first one of a pile and a scoop of food cannot be visually contained within the first indicating outline, the first one of a pile and a scoop of food contains more than the desired portion of the food.

10. The method of claim 9, further comprising removing some of the food from the first one of a pile and a scoop of food if all of the first one of a pile and a scoop of food cannot be visually contained within the first indicating outline.

11. The method claim 10, wherein the transparent base further comprises a second portion-indicating outline, the method further comprising determining whether a second one of a pile and a scoop of a second food is visually contained within the second portion-indicating outline, whereby if all of the second one of a pile and a scoop of food is visually contained within the first indicating outline, the second one of a pile and a scoop of food contains no more than a desired portion of the second food.

12. The method of claim 9, wherein a size and shape of the first portion-indicating outline is based on an expected Angle of Repose of the first food.

13. A method of making a portion control aid comprising:
providing a transparent sheet; and
marking a first portion-indicating outline on the transparent sheet, wherein a size and a shape of the first portion-indicating outline corresponds with an expected perimeter of a desired portion of a first food.

14. The method of claim 13, wherein the size and the shape of the first portion-indicating outline is based on an expected Angle of Repose of a pile of the first food.

15. The method of claim 13, wherein the size and the shape of the first portion-indicating outline is based on a perimeter of a tightly packed single layer of the first food.

16. The method of claim 13, wherein the size and shape of the first portion-indicating outline is based on a size and shape of a single piece of the first food.

17. The method of claim 13, further comprising marking a second portion-indicating outline on the transparent sheet, wherein a size and a shape of the second portion-indicating outline corresponds with an expected perimeter of a desired portion of a second food based on an Angle of Repose of one of a pile and a scoop of the second food.

18. The method of claim 17, further comprising marking the transparent base with labels indicating what food is associated with the first portion-indicating outline and what food is associated with the second portion-indicating outline.

19. The method of claim 17 comprising using a first color for the first portion-indicating outline and using a second color different than the first color for the second portion-indicating outline.

20. The method of claim 13 wherein the surface is a display of an electronic device.
